(19) United States
(12) Patent Application Publication
(10) Pub. No.: US 2024/0386352 A1
(43) Pub. Date: Nov. 21, 2024

(54) INTELLIGENT PREDICTION OF PRODUCT/PROJECT EXECUTION OUTCOME AND LIFESPAN ESTIMATION

(71) Applicant: Dell Products L.P., Round Rock, TX (US)

(72) Inventors: Bijan Kumar Mohanty, Austin, TX (US); Cleber Souza, Porto Alegre (BR); Hung Dinh, Austin, TX (US)

(73) Assignee: Dell Products L.P., Round Rock, TX (US)

(21) Appl. No.: 18/317,242

(22) Filed: May 15, 2023

(51) Int. Cl. G06Q 10/0637

(52) U.S. Cl. CPC G06Q 10/06375

(57) ABSTRACT

An example methodology includes, by a computing device, receiving information regarding a product from another computing device and determining one or more relevant features from the information regarding the product, the one or more relevant features influencing predictions of a product execution outcome and a lifespan estimate. The method also includes, by the computing device, generating, using a multi-target machine learning (ML) model, a first prediction of an execution outcome of the product and a second prediction of a lifespan estimate of the product based on the determined one or more relevant features, and sending the first and second predictions to the another computing device.

### BACKGROUND

Product development and delivery are continuously evolving with the continuous advancement and changes in technology, market, and customer expectations. In addition, increasing interest in continuous integration and continuous delivery/continuous deployment (CI/CD) and DevOps have enabled agile deployment of microservice as containerized, cloud-native applications. For example, organizations, such as companies, enterprises, and manufacturers, are increasingly making cloud-native applications and microservices an integral part of their growth strategies. Many organizations have moved to a hybrid cloud approach, which leverages public clouds as well as private clouds, to deploy their products and projects. In addition, organizations are increasingly using many commercial platforms to build products both as on-prem or on the cloud (for example, Salesforce, ServiceNow etc.). As a result of such advances and evolvements, product/project development and execution are becoming increasingly complex.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, receiving information regarding a product from another computing device and determining one or more relevant features from the information regarding the product, the one or more relevant features influencing predictions of a product execution outcome and a lifespan estimate. The method also includes, by the computing device, generating, using a multi-target machine learning (ML) model, a first prediction of an execution outcome of the product and a second prediction of a lifespan estimate of the product based on the determined one or more relevant features, and sending the first and second predictions to the another computing device.

In some embodiments, the multi-target ML model includes a multi-output deep neural network (DNN). In one aspect, the multi-output DNN predicts a classification response and a regression response, wherein the classification response is the first prediction of the execution outcome of the product and the regression response is the second prediction of the lifespan estimate of the product.

In some embodiments, the multi-target ML model is generated using a training dataset generated from a corpus of historical product execution and lifespan data of an organization.

In some embodiments, the training dataset comprises a plurality of training/testing samples, wherein each training/testing sample of the plurality of training/testing samples includes one or more features extracted from the historical product execution and lifespan data, wherein the one or more features includes a feature indicative of a product type associated with the product.

In some embodiments, the training dataset comprises a plurality of training/testing samples, wherein each training/testing sample of the plurality of training/testing samples includes one or more features extracted from the historical product execution and lifespan data, wherein the one or more features includes a feature indicative of a business domain associated with the product.

In some embodiments, the training dataset comprises a plurality of training/testing samples, wherein each training/testing sample of the plurality of training/testing samples includes one or more features extracted from the historical product execution and lifespan data, wherein the one or more features includes a feature indicative of a language associated with the product.

In some embodiments, the training dataset comprises a plurality of training/testing samples, wherein each training/testing sample of the plurality of training/testing samples includes one or more features extracted from the historical product execution and lifespan data, wherein the one or more features includes a feature indicative of a database associated with the product.

In some embodiments, the training dataset comprises a plurality of training/testing samples, wherein each training/testing sample of the plurality of training/testing samples includes one or more features extracted from the historical product execution and lifespan data, wherein the one or more features includes a feature indicative of a consumption associated with the product.

In some embodiments, the training dataset comprises a plurality of training/testing samples, wherein each training/testing sample of the plurality of training/testing samples includes one or more features extracted from the historical product execution and lifespan data, wherein the one or more features includes a feature indicative of a deployment associated with the product.

According to another illustrative embodiment provided to illustrate the broader concepts described herein, a system includes one or more non-transitory machine-readable mediums configured to store instructions and one or more processors configured to execute the instructions stored on the one or more non-transitory machine-readable mediums. Execution of the instructions causes the one or more processors to carry out a process corresponding to the aforementioned method or any described embodiment thereof.

According to another illustrative embodiment provided to illustrate the broader concepts described herein, a non-transitory machine-readable medium encodes instructions that when executed by one or more processors cause a process to be carried out, the process corresponding to the aforementioned method or any described embodiment thereof.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a block diagram of an illustrative system for intelligent prediction of product execution outcome and lifespan estimation, in accordance with an embodiment of the present disclosure.

FIG. 5 is a diagram illustrating a portion of a data structure that can be used to store information about relevant features of a training dataset for training a multi-target machine learning (ML) model to predict an execution outcome and lifespan estimation of a product, in accordance with an embodiment of the present disclosure.

FIG. 6 is a diagram illustrating an example architecture of a multi-output deep neural network (DNN) for a product execution outcome module, in accordance with an embodiment of the present disclosure.

FIG. 7 is a diagram showing an example topology that can be used to predict a product execution outcome and a lifespan estimation, in accordance with an embodiment of the present disclosure.

FIG. 8 is a flow diagram of an example process for predictions of a product execution outcome and a lifespan estimate, in accordance with an embodiment of the present disclosure.

### DETAILED DESCRIPTION

Besides clear goals and requirements, there are many other factors that influence the success or failure of a product/project. Many of these factors are technology related as well as business related. With technology and hosting platforms evolving at a rapid pace, it is becoming increasingly difficult to determine outcomes of products/projects at the time of planning. Existing project management tools have capabilities to manage products and projects during their planning and execution stages. However, these tools lack the intelligence for determining the outcome of products/projects at the time of planning with a high degree of accuracy.

Disclosed herein are concepts, structures, and techniques for predicting execution outcomes of products/projects well as estimates of lifespans of the products/projects at time of planning. The products/projects belong to or otherwise are associated with an organization, such as a company of other enterprise. In other words, the products and projects are those planned and undertaken by the organization. Such planned products and projects are sometimes referred to herein more simply as “products.” The prediction of execution outcomes and lifespan estimates of new planned products can be achieved by leveraging insights derived from past product execution experiences. In some embodiments, prediction of a product execution outcome and estimate of a lifespan of a product can be achieved using a multi-target machine learning (ML) model. For example, in some such embodiments, a ML algorithm capable of prediction and lifespan estimation, such as a deep neural network (DNN), may be trained using a training dataset generated from execution outcome and lifespan data of the organization's historical products. The execution outcome and lifespan data of the various types of historical products include the business domain, product type (e.g., custom, commercial), technology (e.g., programming language, database, APIs), hosting platforms (e.g., public cloud, private cloud, hybrid), and consumption (e.g., external, internal, both), among others. Such historical data are an excellent training indicator of the future execution outcome and lifespan prediction of new products. Once trained, the multi-target ML model can, in response to input of information about a new planned product, output two predictions simultaneously: one prediction of an execution outcome of the planned product and another prediction of a lifespan estimate of the planned product. This insight into the execution outcome and estimated lifespan can enable the organization (e.g., management) to make better informed decisions while executing the product to improve the predicted outcome/lifespan estimation. For example, decisions on technology choices, deployment platforms and scope/goal of a planned product can essentially improve the outcome as well as lifespan of the planned product.

The use of the multi-target ML model to output the two predictions simultaneously may provide benefits over using a combination of two separate single output ML models. For example, training two single output ML models may take longer and be more computationally expensive than training the multi-target ML model in accordance with implementations of this disclosure. As another example, training the multi-target ML model in accordance with implementations of this disclosure may optimize for the multiple targets (e.g., two targets) together which may improve the accuracy of the output predictions compared to optimizing for a single target as in the case of using single output ML models.

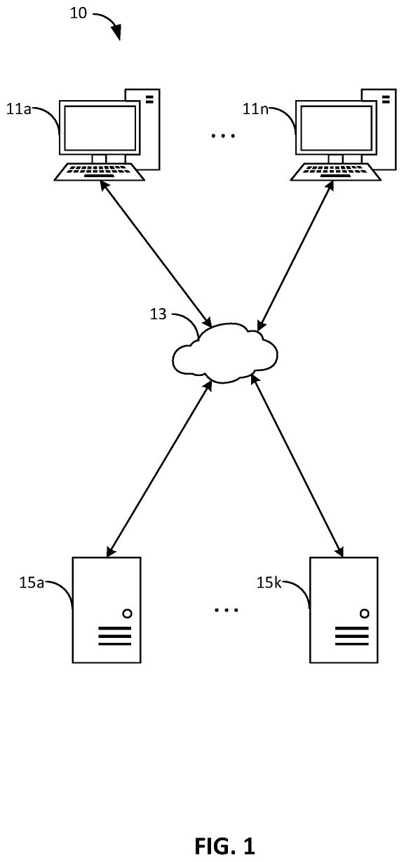

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to as a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

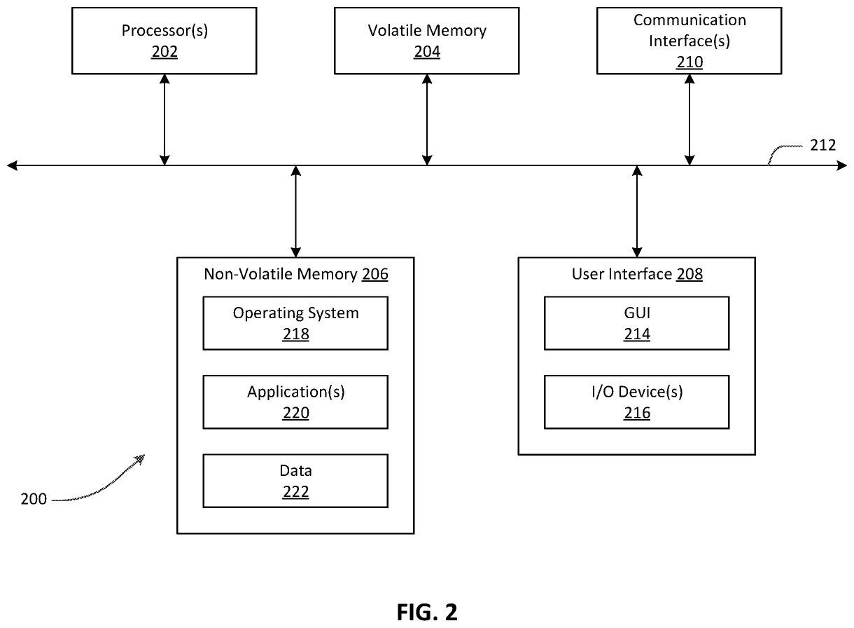

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

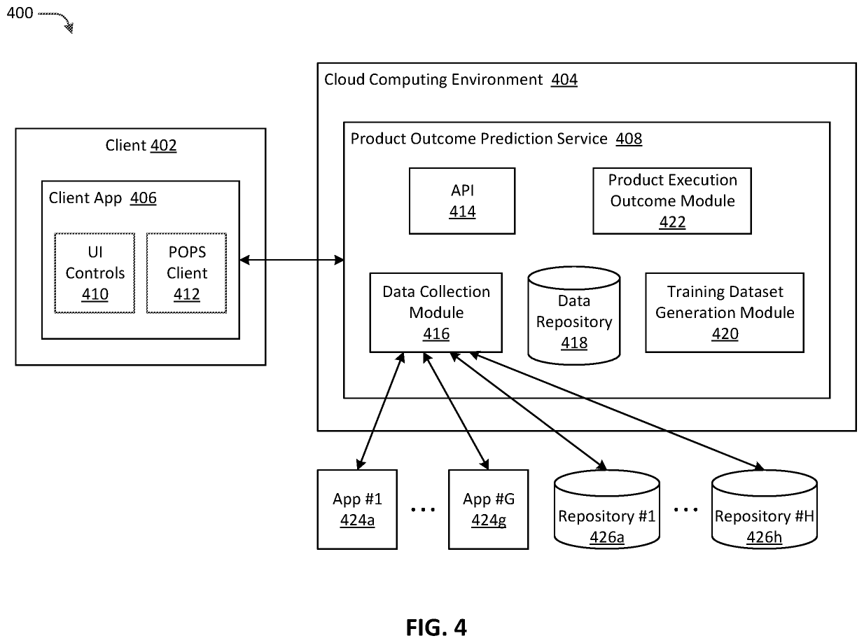

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 7). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital, or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

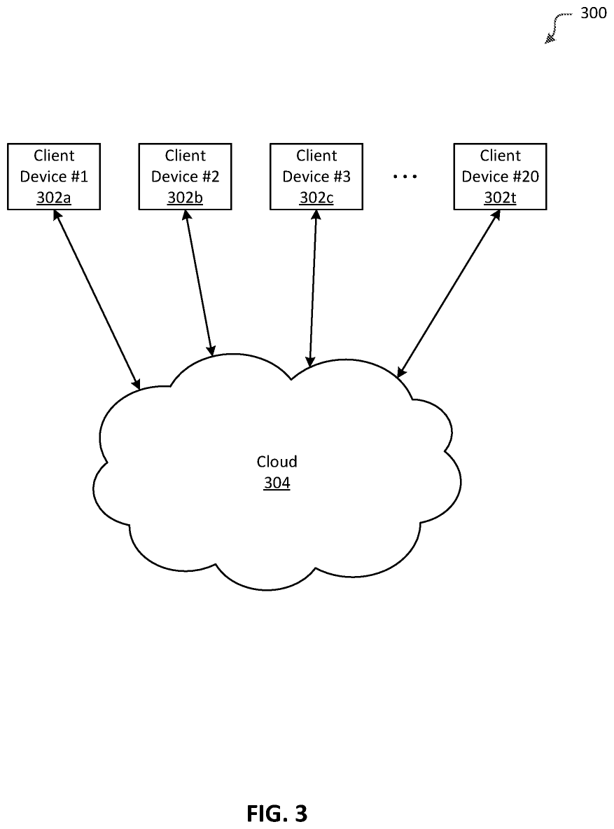

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (SaaS), Platform as a Service (PaaS), Infrastructure as a Service (IaaS), and/or Desktop as a Service (DaaS), for example. IaaS may refer to a user renting the use of infrastructure resources that are needed during a specified period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

FIG. 4 is a block diagram of an illustrative system 400 for intelligent prediction of product execution outcome and lifespan estimation, in accordance with an embodiment of the present disclosure. Illustrative system 400 includes a client application 406 operable to run on a client 402 and configured to communicate with a cloud computing environment 404 via one or more computer networks. Client 402 and cloud computing environment 404 of FIG. 4 can be the same as or similar to client 11 of FIG. 1 and cloud computing environment 300 of FIG. 3, respectively.

As shown in FIG. 4, a product outcome prediction service 408 can be provided as a service (e.g., a microservice) within cloud computing environment 404. For example, an organization such as a company, an enterprise, or other entity that develops products (e.g., applications, application software, etc.) and/or undertakes projects, for instance, may implement and use product outcome prediction service 408 to intelligently predict execution outcomes of products/projects well as estimates of lifespans of the products/projects at time of planning. Client application 406 and product outcome prediction service 408 can interoperate to provide intelligent prediction of execution outcomes of products/projects well as estimates of lifespans of the products/projects, as variously disclosed herein. To promote clarity in the drawings, FIG. 4 shows a single client application 406 communicably coupled to product outcome prediction service 408. However, embodiments of product outcome prediction service 408 can be used to service many client applications (e.g., client applications 406) running on client devices (e.g., clients 402) associated with one or more organizations and/or users. Client application 406 and/or product outcome prediction service 408 may be implemented as computer instructions executable to perform the corresponding functions disclosed herein. Client application 406 and product outcome prediction service 408 can be logically and/or physically organized into one or more components. In the example of FIG. 4, client application 406 includes UI controls 410 and a product outcome prediction service (POPS) client 412. Also, in this example, product outcome prediction service 408 includes an application programming interface (API) module 414, a data collection module 416, a data repository 418, a training dataset generation module 420, and a product execution outcome module 422.

The client-side client application 406 can communicate with the cloud-side product outcome prediction service 408 using an API. For example, client application 406 can utilize POPS client 412 to send requests (or “messages”) to product outcome prediction service 408 wherein the requests are received and processed by API module 414 or one or more other components of product outcome prediction service 408. Likewise, product outcome prediction service 408 can utilize API module 414 to send responses/messages to client application 406 wherein the responses/messages are received and processed by POPS client 412 or one or more other components of client application 406.

Client application 406 can include various UI controls 410 that enable a user (e.g., a user of client 402), such as a product/project manager or other associate within or associated with an organization, to access and interact with product outcome prediction service 408. For example, UI controls 410 can include UI elements/controls, such as input fields and text fields, with which the user can specify details about a product for which execution outcome prediction and lifespan estimation is being requested. The specified product may be, for example, a new product that is being planned/considered for development/delivery by the organization. In the context of a project, the specified product may be, for example, a project undertaken to research or design a new product. In some implementations, some or all the UI elements/controls can be included in or otherwise provided via one or more electronic forms configured to provide a series of fields where data is collected, for example. UI controls 410 can include UI elements/controls that a user can click/tap to request predictions of execution outcome and lifespan estimate of the specified product. In response to the user's input, client application 406 can send a message to product outcome prediction service 408 requesting predictions of execution outcome and lifespan estimate of the specified product.

Client application 406 can also include UI controls 410 that enable a user to view predictions of a product execution outcome and lifespan estimate. For example, in some embodiments, responsive to sending a request for predictions of execution outcome and lifespan estimate of a product, client application 406 may receive a response from product outcome prediction service 408 which includes a prediction of an execution outcome of the product and a prediction of an estimated lifespan of the product once the product is executed. UI controls 410 can include a button or other type of control/element for displaying the predictions included in the response from product outcome prediction service 408, for example, on a display connected to or otherwise associated with client 402. The user can then take appropriate action based on the provided predictions. For example, the user may prioritize execution of the new product (the planned product) by the product development team or cancel or recommend canceling further development of the new product (the planned product), among other possible actions.

In the embodiment of FIG. 4, client application 406 is shown as a stand-alone client application. In other embodiments, client application 406 may be implemented as a plug-in or extension to another application (e.g., a web browser) on client 402, such as, for example, an enterprise client application. In such embodiments, UI controls 410 may be accessed within the other application in which client application 406 is implemented (e.g., accessed within the enterprise client application).

Referring to the cloud-side product outcome prediction service 408, data collection module 416 is operable to collect or otherwise retrieve the organization's execution outcome and lifespan data of its historical products from one or more data sources. Such data is sometimes referred to herein as “historical product execution and lifespan data.” The data sources can include, for example, one or more applications 424a-424g (individually referred to herein as application 424 or collectively referred to herein as applications 424) and one or more repositories 426a-426h (individually referred to herein as repository 426 or collectively referred to herein as repositories 426). Applications 424 can include various types of applications such as software as a service (SaaS) applications, web applications, and desktop applications, to provide a few examples. In some embodiments, applications 424 may correspond to the organization's product management applications/systems and project management applications/systems. Repositories 426 can include various types of data repositories such as conventional file systems, cloud-based storage services such as SHAREFILE, BITBUCKET, DROPBOX, and MICROSOFT ONEDRIVE, and web servers that host files, documents, and other materials. In some embodiments, repositories 426 may correspond to the organization's repositories used for storing at least some of the historical product execution and lifespan data.

Data collection module 416 can utilize application programming interfaces (APIs) provided by the various data sources to collect information and materials therefrom. For example, data collection module 416 can use a REST-based API or other suitable API provided by a product management application/system or project management application/system to collect information therefrom (e.g., to collect the historical product execution and lifespan data). In the case of web-based applications, data collection module 416 can use a Web API provided by a web application to collect information therefrom. As another example, data collection module 416 can use a file system interface to retrieve the files containing historical product execution and lifespan data and related information, etc., from a file system. As yet another example, data collection module 416 can use an API to collect documents containing historical product execution and lifespan data and related information, etc., from a cloud-based storage service. A particular data source (e.g., application 424 and/or repository 426) can be hosted within a cloud computing environment (e.g., the cloud computing environment of product outcome prediction service 408 or a different cloud computing environment) or within an on-premises data center (e.g., an on-premises data center of an organization that utilizes product outcome prediction service 408).

In cases where an application or data repository does not provide an interface or API, other means, such as printing and/or imaging, may be utilized to collect information therefrom (e.g., generate an image of printed document containing information/data about a historical product). Optical character recognition (OCR) technology can then be used to convert the image of the content to textual data.

As mentioned previously, data collection module 416 can collect the historical product execution and lifespan data from one or more data sources. The historical product execution and lifespan data includes development, deployment, and run data of the organization's historical products. As an example, for a given historical product, the execution and lifespan data can include information about the product (e.g., details/specifics of the product) along with data which indicates whether the product was successfully executed (e.g., whether the historical product was successfully developed/delivered) and a lifespan of the product in the case where the product was successfully executed. Data collection module 416 can store the historical product execution and lifespan data collected from the various data sources within data repository 418, where it can subsequently be retrieved and used. For example, the historical product execution and lifespan data and other materials from data repository 418 can be retrieved and used to generate a training dataset for use in generating an ML model (e.g., a multi-target ML model). In some embodiments, data repository 418 may correspond to a storage service within the computing environment of product outcome prediction service 408.

In some embodiments, data collection module 416 can collect the historical product execution and lifespan data from one or more of the various data sources on a continuous or periodic basis (e.g., according to a predetermined schedule specified by the organization). Additionally or alternatively, data collection module 416 can collect the historical product execution and lifespan data from one or more of the various data sources in response to an input. For example, a user of product outcome prediction service 408 can use their client 402 and issue a request to collect historical product execution and lifespan data from one or more data sources. The request may indicate a past period for the historical products. In response, data collection module 416 can collect the execution and lifespan data for the historical products from the indicated past period from the one or more data sources.

Training dataset generation module 420 is operable to generate (or “create”) a training dataset for use in generating (e.g., training, testing, etc.) a ML model (e.g., a multi-target ML model) to predict a product execution outcome (e.g., product execution success) and an estimated lifespan of the product. Training dataset generation module 420 can retrieve from data repository 418 a corpus of historical product execution and lifespan data from which to generate the training dataset. In one embodiment, the historical product execution and lifespan data may be of the organization's products from the past N years (e.g., N=3 years, 4 years, or another suitable period). The value of N may be configured as part of the organization's policy or a user preference.

To generate a training dataset, training dataset generation module 420 may preprocess the retrieved corpus of historical product execution and lifespan data to be in a form that is suitable for training and testing the ML model (e.g., a multi-target ML model). In one embodiment, training dataset generation module 420 may utilize natural language processing (NLP) algorithms and techniques to preprocess the retrieved historical product execution and lifespan data. For example, the data preprocessing may include tokenization (e.g., splitting a phrase, sentence, paragraph, or an entire text document into smaller units, such as individual words or terms), noise removal (e.g., removing whitespaces, characters, digits, and items of text which can interfere with the extraction of features from the data), stop words removal, stemming, and/or lemmatization.

The data preprocessing may also include placing the data into a tabular format. In the table, the structured columns represent the features (also called “variables”), and each row represents an observation or instance (e.g., a historical product). Thus, each column in the table shows a different feature of the instance. The data preprocessing may also include placing the data (information) in the table into a format that is suitable for training a model (e.g., placing into a format that is suitable for a DNN or other suitable learning algorithm to learn from to generate (or “build”) the ML model, e.g., a multi-target ML model). For example, since machine learning deals with numerical values, textual categorical values (i.e., free text) in the columns can be converted (i.e., encoded) into numerical values. According to one embodiment, the textual categorical values may be encoded using label encoding. According to alternative embodiments, the textual categorical values may be encoded using one-hot encoding or other suitable encoding methods.

The data preprocessing may also include null data handling (e.g., the handling of missing values in the table). According to one embodiment, null or missing values in a column (a feature) may be replaced by median of the other values in that column. For example, median imputation may be performed using a median imputation technique such as that provided by Scikit-learn (Sklearn). According to alternative embodiments, observations in the table with null or missing values in a column may be replaced by a mode or mean value of the values in that column or removed from the table.

The data preprocessing may also include feature selection and/or data engineering to determine or identify the relevant or important features from the noisy data (e.g., the unnecessary features and the features that are highly correlated). The relevant/important features are the features that are more correlated with the thing being predicted by the trained model (e.g., a product execution outcome and a lifespan estimation). A variety of feature engineering techniques, such as exploratory data analysis (EDA) and/or bivariate data analysis with multivariate-variate plots and/or correlation heatmaps and diagrams, among others, may be used to determine the relevant features. For example, for a particular historical product, the relevant features may include important features from the product data such as date/time, product name, product time, business domain, technologies used (e.g., language, database, stack, etc.), consumption pattern (e.g., internal, external, both, etc.), and deployment/hosting platform (e.g., public cloud, private cloud, hybrid cloud, etc.), among others.

The data preprocessing can include adding an informative label to each instance in the training dataset. As explained above, each instance in the training dataset is a historical product of the organization. In some implementations, one or more labels (e.g., an indication of product execution outcome (e.g., product successfully developed/delivered or product not successfully developed/delivered) and an indication of lifespan duration) can be added to each instance in the training dataset. The label added to each instance, i.e., the label added to each historical product, is a representation of a prediction for that instance in the training dataset (e.g., the things being predicted) and helps a machine learning model learn to make the prediction when encountered in data without a label. For example, for a given historical product, a first label may indicate whether the historical product was successfully executed (e.g., successfully developed/delivered) and a second label may indicate a lifespan of the historical product.

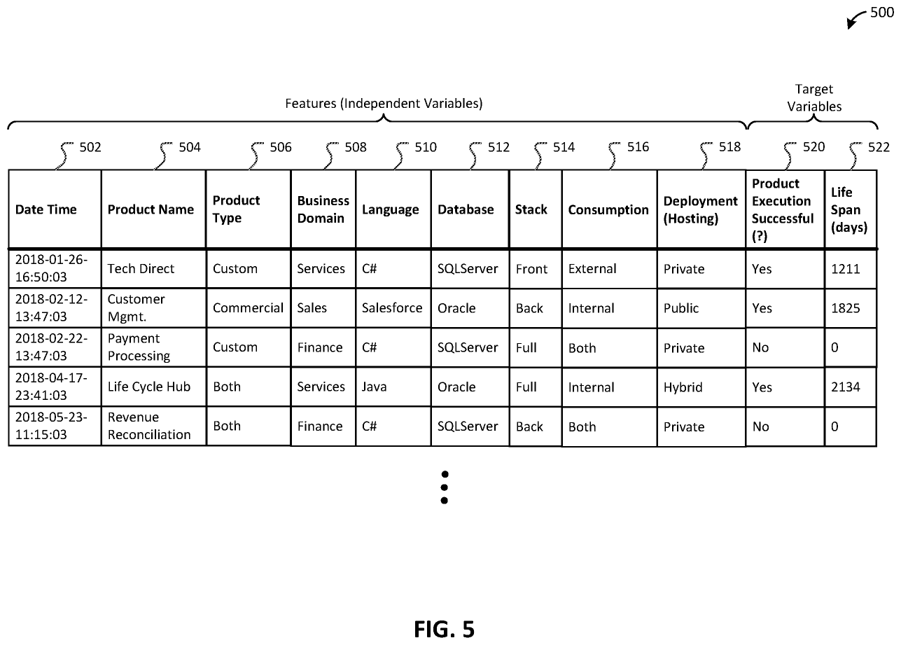

Each instance in the table may represent a training/testing sample (i.e., an instance of a training/testing sample) in the training dataset and each column may be a relevant feature of the training/testing sample. As previously described, each training/testing sample may correspond to a historical product of the organization. In a training/testing sample, the relevant features are the independent variables and the things being predicted (e.g., an execution outcome and a lifespan estimation) are the dependent variables (e.g., labels). In some embodiments, the individual training/testing samples may be used to generate a feature vector, which is a multi-dimensional vector of elements or components that represent the features in a training/testing sample. In such embodiments, the generated feature vectors may be used for training or testing a multi-target ML model using supervised learning to make the predictions. Examples of relevant features of a training dataset for training/testing the multi-target ML model for predicting a product execution outcome and a lifespan estimate are provided below with respect to FIG. 5.

In some embodiments, training dataset generation module 420 may reduce the number of features in the training dataset. For example, since the training dataset is being generated from the corpus of historical product execution and lifespan data, the number of features (or input variables) in the dataset may be very large. The large number of input features can result in poor performance for machine learning algorithms. For example, in one embodiment, training dataset generation module 420 can utilize dimensionality reduction techniques, such as principal component analysis (PCA), to reduce the dimension of the training dataset (e.g., reduce the number of features in the dataset), hence improving the model's accuracy and performance.

In some embodiments, training dataset generation module 420 can generate the training dataset on a continuous or periodic basis (e.g., according to a predetermined schedule specified by the organization). Additionally or alternatively, training dataset generation module 420 can generate the training dataset in response to an input. For example, a user of product outcome prediction service 408 can use their client 402 and issue a request to generate a training dataset. In some cases, the request may indicate a past period for the historical products whose execution and lifespan data are to be used in generating the training dataset. In response, training dataset generation module 420 can retrieve the historical product execution and lifespan data for generating the training dataset from data repository 418 and generate the training dataset using the retrieved historical product execution and lifespan data. Training dataset generation module 420 can store the generated training dataset within data repository 418, where it can subsequently be retrieved and used (e.g., retrieved and used to build a multi-target ML model for predicting a product execution outcome and a lifespan estimation).

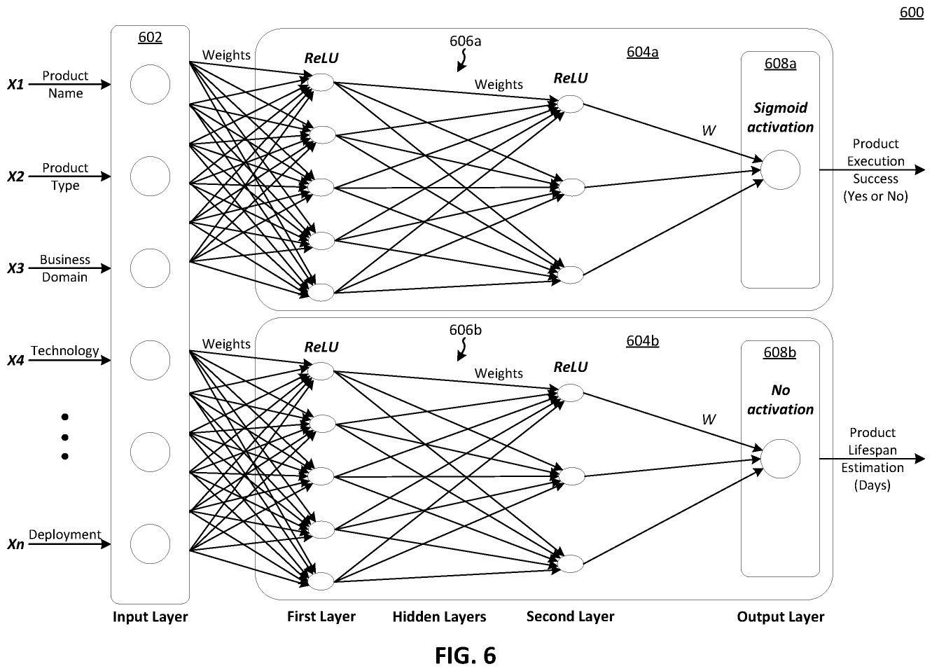

Still referring to product outcome prediction service 408, product execution outcome module 422 is operable to predict a product execution outcome and a lifespan estimation. In other words, product execution outcome module 422 is operable to predict, for an input of information about a product (e.g., a new product that is being planned), an execution outcome and a lifespan estimate of the product. In some embodiments, product execution outcome module 422 can include an ML algorithm that supports outputting multiple predictions, such as a DNN, trained to simultaneously predict a classification response and predict a regression response using a training dataset generated from the organization's multi-dimensional historical product execution and lifespan data. The training dataset may be retrieved from data repository 418. Once the multi-target ML model is trained, the output classification response can be a prediction of an execution outcome and the output regression response can be a prediction of a lifespan estimate. For example, in response to input of information about a product (e.g., a new product that is being planned), the multi-target ML model can predict an execution outcome and a lifespan estimate of the input product based on the learned behaviors (or “trends”) in the training dataset. Further description of the training of the ML algorithm that supports outputting multiple predictions (e.g., a DNN) and which can be implemented within product execution outcome module 422 is provided below at least with respect to FIG. 6.

In other embodiments, product execution outcome module 422 can implement two separate single output ML models instead of the multi-target ML model described above. For example, product execution outcome module 422 can include an ML classification model and an ML regression model both generated from the organization's multi-dimensional historical product execution and lifespan data. The trained ML classification model can, in response to input of information about a product (e.g., a new product that is being planned), predict an execution outcome of the input product. The trained ML regression model can, in response to input of the information about the product, predict a lifespan estimate of the input product.

Referring now to FIG. 5 and with continued reference to FIG. 4, shown is a diagram illustrating a portion of a data structure 500 that can be used to store information about relevant features of a training dataset for training a multi-target machine learning (ML) model to predict an execution outcome and lifespan estimation of a product, in accordance with an embodiment of the present disclosure. For example, the training dataset including the illustrated features, as well as other features generated from the organization's historical product execution and lifespan data, may be used to train a multi-output DNN to predict a product execution outcome and a lifespan estimation. As can be seen in FIG. 5, data structure 500 may be in a tabular format in which the structured columns represent the different relevant features (variables) regarding the historical products of the organization and a row represents individual historical product. The relevant features illustrated in data structure 500 are merely examples of features that may be extracted from the historical product execution and lifespan data and used to generate a training dataset and should not be construed to limit the embodiments described herein.

As shown in FIG. 5, the relevant features may include a date time 502, a product name 504, a product type 506, a business domain 508, a language 510, a database 512, a stack 514, a consumption 516, a deployment 518, a product execution successful 520, and a lifespan 522. Date time 502 indicates a date and time at which the planning/development of the historical product was started. Product name 504 indicates the product name assigned to the historical product. Product type 506 indicates the kind or category associated with the historical product. For example, the type or category may be a grouping of similar products. As can be seen in data structure 500, examples of kind/category include custom (e.g., a custom product), commercial (e.g., a commercial product), and both (e.g., a custom and a commercial product).

Business domain 508 indicates an area of activity associated with the historical product. As can be seen in data structure 500, examples of area of activity include services (e.g., the product is for use in or associated with the services domain), sales (e.g., the product is for use in or associated with the sales domain), and finance (e.g., the product is for use in or associated with the finance domain). Language 510 indicates a language (e.g., a programming language) used in developing the historical product. Database 512 indicates a database utilized or interfaced by the historical product. Stack 514 indicates the nature of the historical product. As can be seen in data structure 500, examples of this feature include front (e.g., frontend product in that the product provides a user interface with which users connect to the product, e.g., users connect to the application), back (e.g., backend product in that users do not connect to the product, only systems), and full (e.g., product provides both a user interface and system integrations). Consumption 516 indicates the type of consumption (i.e., type of use) of the historical product. As can be seen in data structure 500, examples of type of consumption include external (e.g., consumption to be external to the organization), internal (e.g., consumption to be internal to the organization), and both (e.g., consumption to be both external to the organization and internal to the organization). Deployment 518 indicates the type of deployment associated with the historical product (e.g., indicates how the historical product is hosted). As can be seen in data structure 500, examples of type of deployment include private (e.g., the product is deployed/hosted on a private cloud exclusive to the organization), public (e.g., the product is deployed/hosted on a public cloud), and hybrid (e.g., the product is deployed/hosted on a combination of a private cloud and a public cloud).

Product execution successful 520 indicates whether the historical product was successfully executed (e.g., “Yes”=product execution successful) or not successfully executed (e.g., “No”=product execution unsuccessful). That is, product execution success 520 indicates the execution outcome of the historical product (e.g., historical product execution successful or historical product execution unsuccessful). Lifespan 522 indicates the lifespan (e.g., number of days) of the historical product. Note that a historical product that is not successfully executed (i.e., not successfully delivered) will not have a lifespan. In other words, a historical product that is not successfully executed will have a lifespan of 0 days. In the context of a project, product execution successful 520 indicates whether the historical project was successfully executed (e.g., “Yes”=project successfully completed) or not successfully executed (e.g., “No”=project not unsuccessfully completed). Also, in this context, lifespan 522 indicates the duration (e.g., number of days) of the historical project (e.g., the duration it took to complete the historical project).

In data structure 500, each row may represent a training/testing sample (i.e., an instance of a training/testing sample) in the training dataset, and each column may show a different relevant feature of the training/testing sample. In some embodiments, the individual training/testing samples may be used to generate a feature vector, which is a multi-dimensional vector of elements or components that represent the features in a training/testing sample. In such embodiments, the generated feature vectors may be used for training/testing a multi-target ML model (e.g., a multi-output DNN of product execution outcome module 422) to predict an execution outcome and a lifespan estimation of a product (e.g., a new product that is being planned). The features date time 502, product name 504, product type 506, business domain 508, language 510, database 512, stack 514, consumption 516, and deployment 518 may be included in a training/testing sample as the independent variables, and product execution successful 520 and lifespan 522 included as two dependent variables (target variables) in the training/testing sample. That is, product execution successful 520 and lifespan 522 are the labels added to the individual training/testing samples. The illustrated independent variables are features that influence performance of the multi-target ML model (i.e., features that are relevant (or influential) in predicting a product execution outcome and lifespan estimation).

Referring now to FIG. 6 and with continued reference to FIGS. 4 and 5, illustrated is an example architecture of a multi-output deep neural network (DNN) for product execution outcome module 422 of FIG. 4, in accordance with an embodiment of the present disclosure. In brief, a DNN includes an input layer for all input variables, multiple hidden layers for feature extraction, and an output layer. Each layer may be composed of a number of nodes or units embodying an artificial neuron (or more simply a “neuron”). Each neuron in a layer receives an input from all the neurons in the preceding layer. In other words, every neuron in each layer is connected to every neuron in the preceding layer and the succeeding layer. As a multi-output DNN, a first output can be a classification response (e.g., a prediction of a product execution outcome) and a second output can be a regression response (e.g., a prediction of a lifespan estimate).

In more detail, and as shown in FIG. 6, a multi-output DNN 600 includes an input layer 602 and two network branches 604a, 604b. Network branch 604a includes one or more hidden layers 606a (e.g., two hidden layers) and an output layer 608a. Network branch 604b includes one or more hidden layers 606b (e.g., two hidden layers) and an output layer 608b. As illustrated in FIG. 6, network branches 604a, 604b may be parallel branches within multi-output DNN 600. In some embodiments, network branch 604a can be trained as a binary classification model that outputs a classification response (e.g., a prediction of a product execution outcome) and network branch 604b can be trained as a regression model that outputs a regression (i.e., numeric) response (e.g., a prediction of a lifespan estimate).

With respect to network branch 604a, hidden layers 606a include two hidden layers, a first hidden layer and a second hidden layer. Each hidden layer in hidden layers 606a can comprise an arbitrary number of neurons, which may depend on the number of neurons included in input layer 602. For example, input layer 602 may be composed of a number of neurons to match (i.e., equal to) the number of input variables (independent variables). Taking as an example the independent variables illustrated in data structure 500 of FIG. 5, input layer 602 may include nine neurons to match the nine independent variables (e.g., date time 502, product name 504, product type 506, business domain 508, language 510, database 512, stack 514, consumption 516, and deployment 518), where each neuron in input layer 602 receives a respective independent variable. Each neuron in the first hidden layer of hidden layers 606a receives an input from all the neurons in input layer 602. Each neuron in the second hidden layer of hidden layers 606a receives an input from all the neurons in the first hidden layer of hidden layers 606b. As a binary classification model, output layer 608a includes a single neuron, which receives an input from all the neurons in the second hidden layer of hidden layers 606a.

Each neuron in hidden layers 606a and the neuron in output layer 608a may be associated with an activation function. For example, according to one embodiment, the activation function for the neurons in hidden layers 606a may be a rectified linear unit (ReLU) activation function. As network branch 604a is to function as a binary classification model, the activation function for the neuron in output layer 608a may be a sigmoid activation function. Since this is a dense neural network, as can be seen in FIG. 6, each neuron in input layer 602 and the different layers of network branch 604a may be coupled to one another. Each coupling (i.e., each interconnection) between two neurons may be associated with a weight, which may be learned during a learning or training phase. Each neuron may also be associated with a bias factor, which may also be learned during a training process. Since network branch 604a is to be used as a binary classifier, binary cross entropy may be used as the loss function, adaptive movement estimation (Adam) as the optimization algorithm, and “accuracy” as the validation metric. In other embodiments, unpublished optimization algorithm designed for neural networks (RMSprop) may be used as the optimization algorithm.

With respect to network branch 604b, hidden layers 606b include two hidden layers, a first hidden layer and a second hidden layer. Each hidden layer in hidden layers 606b can comprise an arbitrary number of neurons, which may depend on the number of neurons included in input layer 602. Each neuron in the first hidden layer of hidden layers 606b receives an input from all the neurons in input layer 602. Each neuron in the second hidden layer of hidden layers 606b receives an input from all the neurons in the first hidden layer of hidden layers 606b. As a regression model, output layer 608b includes a single neuron, which receives an input from all the neurons in the second hidden layer of hidden layers 606b.

Each neuron in hidden layers 606b may be associated with an activation function. For example, according to one embodiment, the activation function for the neurons in hidden layers 606b may be a rectified linear unit (ReLU) activation function. As network branch 604b is to function as a regression model, the neuron in output layer 608b will not contain an activation function. Since this is a dense neural network, as can be seen in FIG. 6, each neuron in input layer 602 and the different layers of network branch 604b may be coupled to one another. Each coupling (i.e., each interconnection) between two neurons may be associated with a weight, which may be learned during the learning or training phase. Each neuron may also be associated with a bias factor, which may also be learned during the training process. Since network branch 604b is to be used as a regressor, mean squared error may be used as the loss function, adaptive movement estimation (Adam) as the optimization algorithm, and “mean squared error (msc); mean absolute error (mae)” as the validation metrics.

Although FIG. 6 shows hidden layers 606a, 606b each composed of only two layers, it will be understood that hidden layers 606a, 606b may be composed of a different number of hidden layers. Also, the number of neurons shown in the first layer and in the second layer of each hidden layer 606a, 606b is for illustration only, and it will be understood that actual numbers of neurons in the first layer and in the second layer of each hidden layer 606a, 606b may be based on the number of neurons in input layer 602.

DNN 600 can be trained by passing the portion of the training dataset designated for training (e.g., 70% of the training dataset designated as the training dataset) and specifying a number of epochs. Note that, since DNN 600 is a multi-output DNN (i.e., generates multi-target predictions), the two target variables (i.e., product execution successful 520 and lifespan 522) are separated from the training dataset. An epoch (one pass of the entire training dataset) is completed once all the observations of the training data are passed through DNN 600. DNN 600 can be validated once DNN 600 completes the specified number of epochs. For example, DNN 600 can process the training dataset and the loss/error value can be calculated and used to assess the performance of DNN 600. The loss value indicates how well DNN 600 is trained. Note that a higher loss value means DNN 600 is not sufficiently trained. In this case, hyperparameter tuning may be performed. Hyperparameter tuning may include, for example, changing the loss function, changing optimizer algorithm, and/or changing the neural network architecture by adding more hidden layers of or to either or both network branches 604a, 604b of DNN 600. Additionally or alternatively, the number of epochs can be also increased to further train DNN 600. In any case, once the loss is reduced to a very small number (ideally close to 0), DNN 600 is sufficiently trained for prediction. Prediction using the model (e.g., DNN 600) can be achieved by passing the independent variables of testing samples in the testing dataset (i.e., for comparing train vs. test) or the real values of a product to predict an execution outcome and a lifespan estimation for the product.

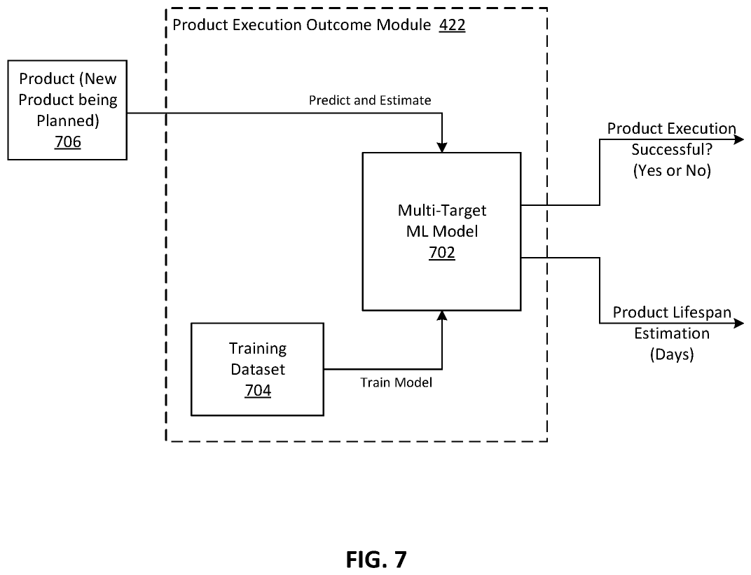

Referring now to FIG. 7, in which like elements of FIG. 4 are shown using like reference designators, shown is a diagram of an example topology that can be used to predict a product execution outcome and a lifespan estimation, in accordance with an embodiment of the present disclosure. As shown in FIG. 7, product execution outcome module 422 includes a multi-target ML model 702. In some embodiments, multi-target ML model 702 may correspond to multi-output DNN 600 of FIG. 6. Multi-target ML model 702 can be trained and tested using machine learning techniques with a training dataset 704. Training dataset 704 can be retrieved from a data repository (e.g., data repository 418 of FIG. 4). As described previously, training dataset 704 for multi-target ML model 702 may be generated from the collected corpus of the organization's historical product execution and lifespan data. Once multi-target ML model 702 is sufficiently trained, product execution outcome module 422 can, in response to receiving information regarding a product (e.g., a new product that is being planned), predict an execution outcome and a lifespan estimate of the product (e.g., predict whether the product will be successfully executed and an estimated lifespan of the product). For example, as shown in FIG. 7, a feature vector 706 that represents a product (e.g., a new product that is being planned), such as some or all the variables that may influence the predictions of a product execution outcome and a lifespan estimate, may be determined and input, passed, or otherwise provided to the trained multi-target ML model 702. In some embodiments, the input feature vector 706 (e.g., the feature vector representing the product) may include some or all the relevant features which were used in training multi-target ML model 702. In response to the input, the trained multi-target ML model 702 can output two responses: a classification response which is a prediction of an execution outcome of the product (e.g., “Yes”=product execution will be successful or “No”=product execution will be unsuccessful) and a regression response which is a prediction of a lifespan estimate of the product (e.g., an estimate of a number of days in the lifespan of the product).

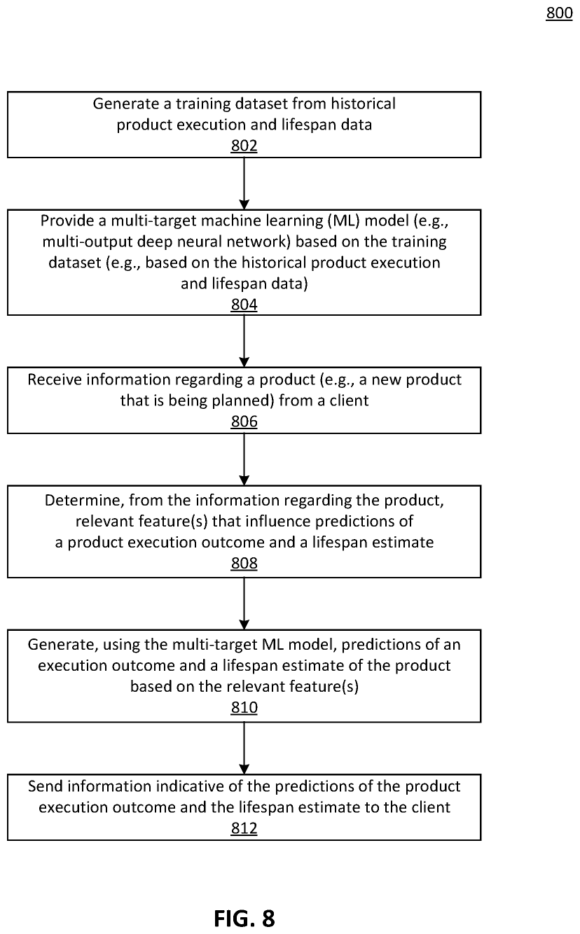

FIG. 8 is a flow diagram of an example process 800 for predictions of a product execution outcome and a lifespan estimate, in accordance with an embodiment of the present disclosure. Illustrative process 800 may be implemented, for example, within system 400 of FIG. 4. In more detail, process 800 may be performed, for example, in whole or in part by data collection module 416, training dataset generation module 420, and product execution outcome module 422, or any combination of these including other components of system 400 described with respect to FIG. 4.

With reference to process 800 of FIG. 8, at 802, a training dataset for use in training a multi-target ML model may be generated from historical product execution and lifespan data of an organization. For example, data collection module 416 may collect the historical product execution and lifespan data from one or more data sources used by the organization to store or maintain such information/data and store the collected historical product execution and lifespan data within data repository 418. Training dataset generation module 420 can then retrieve a corpus of the historical product execution and lifespan data from data repository 418, generate the training dataset, as previously described herein, and store the training dataset within data repository 418.

At 804, a multi-target ML model trained or configured using the training dataset generated from some or all the collected historical product execution and lifespan data may be provided. For example, an ML algorithm that supports outputting multiple predictions may be trained and tested using the training dataset (e.g., training dataset generated by training dataset generation module 420) to build the multi-target ML model. For example, in one implementation, product execution outcome module 422 may retrieve the training dataset from data repository 418 and use the training dataset to train a multi-output DNN, as previously described herein. The trained multi-output DNN can, in response to receiving information regarding a product (e.g., a new product that is being planned), output a classification response (e.g., a prediction of an execution outcome of the product) and a regression response (e.g., a prediction of a lifespan estimate of the product).

At 806, information regarding a product may be received. For example, the information regarding the product may be received along with a request for predictions of execution outcome and lifespan estimate of the product from a client (e.g., client 402 of FIG. 4). The product specified in the request may be a new product that is being planned. For example, the request may be made during the planning stages of the new product. In response to the information regarding the product (e.g., the new product that is being planned) being received, at 808, relevant feature(s) that influence predictions of a product execution outcome and a lifespan estimate may be determined from the received information regarding the product. For example, in one implementation, product execution outcome module 422 may determine the relevant feature(s) that influence predictions of a product execution outcome and a lifespan estimate, as previously described herein.

At 810, predictions of an execution outcome and a lifespan estimate of the product may be generated. For example, product execution outcome module 422 may generate a feature vector that represents the relevant feature(s) of the product specified in the request. Product execution outcome module 422 can then input the generated feature vector to the multi-target ML model (e.g., multi-output DNN), which outputs a first prediction of an execution outcome of the input product and a second prediction of a lifespan estimate of the input product. The predictions generated using the multi-target ML model are based on the relevant feature(s) input to the multi-target ML model. The predictions by the multi-target ML model are based on the learned behaviors (or “trends”) in the training dataset used in training the multi-target ML model.

At 812, information indicative of the predictions of the execution outcome and the lifespan estimate of the product specified in the request may be sent or otherwise provided to the client and presented to a user (e.g., the user who sent the request for predictions of execution outcome and lifespan estimate). For example, the information indicative of the predictions may be presented within a user interface of a client application on the client. The user can then take one or more appropriate actions based on the provided predictions (e.g., prioritize or not prioritize development of the new product that is being planned, cancel or delay the development of the new product, make changes to the new product specification, etc.).

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporancous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
receiving, by a computing device, information regarding a product from another computing device;
determining, by the computing device, one or more relevant features from the information regarding the product, the one or more relevant features influencing predictions of a product execution outcome and a lifespan estimate;
generating, by the computing device using a multi-target machine learning (ML) model, a first prediction of an execution outcome of the product and a second prediction of a lifespan estimate of the product based on the determined one or more relevant features; and
sending, by the computing device, the first and second predictions to the another computing device.

2. The method of claim 1, wherein the multi-target ML model includes a multi-output deep neural network (DNN).

3. The method of claim 2, wherein the multi-output DNN predicts a classification response and a regression response, wherein the classification response is the first prediction of the execution outcome of the product and the regression response is the second prediction of the lifespan estimate of the product.

4. The method of claim 1, wherein the multi-target ML model is generated using a training dataset generated from a corpus of historical product execution and lifespan data of an organization.

5. The method of claim 4, wherein the training dataset comprises a plurality of training/testing samples, wherein each training/testing sample of the plurality of training/testing samples includes one or more features extracted from the historical product execution and lifespan data, wherein the one or more features includes a feature indicative of a product type associated with the product.

6. The method of claim 4, wherein the training dataset comprises a plurality of training/testing samples, wherein each training/testing sample of the plurality of training/testing samples includes one or more features extracted from the historical product execution and lifespan data, wherein the one or more features includes a feature indicative of a business domain associated with the product.

7. The method of claim 4, wherein the training dataset comprises a plurality of training/testing samples, wherein each training/testing sample of the plurality of training/testing samples includes one or more features extracted from the historical product execution and lifespan data, wherein the one or more features includes a feature indicative of a language associated with the product.

8. The method of claim 4, wherein the training dataset comprises a plurality of training/testing samples, wherein each training/testing sample of the plurality of training/testing samples includes one or more features extracted from the historical product execution and lifespan data, wherein the one or more features includes a feature indicative of a database associated with the product.

9. The method of claim 4, wherein the training dataset comprises a plurality of training/testing samples, wherein each training/testing sample of the plurality of training/testing samples includes one or more features extracted from the historical product execution and lifespan data, wherein the one or more features includes a feature indicative of a consumption associated with the product.

10. The method of claim 4, wherein the training dataset comprises a plurality of training/testing samples, wherein each training/testing sample of the plurality of training/testing samples includes one or more features extracted from the historical product execution and lifespan data, wherein the one or more relevant includes a feature indicative of a deployment associated with the product.

11. A system comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
receiving information regarding a product from a computing device;
determining one or more relevant features from the information regarding the product, the one or more relevant features influencing predictions of a product execution outcome and a lifespan estimate;
generating, using a multi-target machine learning (ML) model, a first prediction of an execution outcome of the product and a second prediction of a lifespan estimate of the product based on the determined one or more relevant features; and
sending the first and second predictions to the computing device.

12. The system of claim 11, wherein the multi-target ML model includes a multi-output deep neural network (DNN).

13. The system of claim 12, wherein the multi-output DNN predicts a classification response and a regression response, wherein the classification response is the first prediction of the execution outcome of the product and the regression response is the second prediction of the lifespan estimate of the product.

14. The system of claim 11, wherein the multi-target ML model is generated using a training dataset generated from a corpus of historical product execution and lifespan data of an organization.

15. The system of claim 14, wherein the training dataset comprises a plurality of training/testing samples, wherein each training/testing sample of the plurality of training/testing samples includes one or more features extracted from the historical product execution and lifespan data, wherein the one or more features includes a feature indicative of one of a product type associated with the product, a business domain associated with the product, a language associated with the product, a database associated with the product, a consumption associated with the product, or a deployment associated with the product.

16. A non-transitory machine-readable medium encoding instructions that when executed by one or more processors cause a process to be carried out, the process including:
receiving information regarding a product from a computing device;
determining one or more relevant features from the information regarding the product, the one or more relevant features influencing predictions of a product execution outcome and a lifespan estimate;
generating, using a multi-target machine learning (ML) model, a first prediction of an execution outcome of the product and a second prediction of a lifespan estimate of the product based on the determined one or more relevant features; and
sending the first and second predictions to the computing device.

17. The machine-readable medium of claim 16, wherein the multi-target ML model includes a multi-output deep neural network (DNN).

18. The machine-readable medium of claim 17, wherein the multi-output DNN predicts a classification response and a regression response, wherein the classification response is the first prediction of the execution outcome of the product and the regression response is the second prediction of the lifespan estimate of the product.

19. The machine-readable medium of claim 16, wherein the multi-target ML model is generated using a training dataset generated from a corpus of historical product execution and lifespan data of an organization.

20. The machine-readable medium of claim 19, wherein the training dataset comprises a plurality of training/testing samples, wherein each training/testing sample of the plurality of training/testing samples includes one or more features extracted from the historical product execution and lifespan data, wherein the one or more features includes a feature indicative of one of a product type associated with the product, a business domain associated with the product, a language associated with the product, a database associated with the product, a consumption associated with the product, or a deployment associated with the product.
